(19) United States
(12) Patent Application Publication
(10) Pub. No.: US 2010/0034448 A1
(43) Pub. Date: Feb. 11, 2010

(54) Method And Apparatus For Frame Interpolation Of Ultrasound Image In Ultrasound System

(76) Inventor: Kwanghee Lee, Daejeon-si (KR)

Correspondence Address: JONES DAY, 222 EAST 41ST ST, NEW YORK, NY, 10017, US

(21) Appl. No.: 12/410,200

(22) Filed: Mar. 24, 2009

(30) Foreign Application Priority Data
Aug. 6, 2008 (KR) 10-2008-0076932

(51) Int. Cl. G06K 9/00; G06K 9/32

(52) U.S. Cl. 382/131; 382/300

(57) ABSTRACT

A method and apparatus for frame interpolation of an ultrasound image is provided. The frame interpolation method includes: calculating an optical flow using an ultrasound image of a first frame and an ultrasound image of a second frame; determining an interpolated frame between the first frame and the second frame; calculating an optical flow of the interpolated frame using the calculated optical flow; and creating an ultrasound image in the interpolated frame from the optical flow of the interpolated frame.

### CROSS-REFERENCE TO RELATED APPLICATION

This application claims the benefit of Korean Patent Application No. 10-2008-0076932, filed on Aug. 6, 2008, in the Korean Intellectual Property Office, the entire disclosure of which is incorporated herein by reference.

### BACKGROUND

1. Field of the Invention

Embodiments of the present invention relate to a method and apparatus for frame interpolation, and more particularly, to a method and apparatus for performing frame interpolation of an ultrasound image using an optical flow.

2. Description of the Related Art

An ultrasound system denotes a system that may emit ultrasound signals from the body surface of a subject to a select interior portion of the body and provide images associated with blood flow or a section of soft tissue using information associated with reflected ultrasound signals.

The ultrasound system is generally small and inexpensive. Also, the ultrasound system has no absorbed dose such as with X rays and the like and thus is highly stable. The ultrasound system is being widely used together with other image diagnostic apparatuses such as an X-ray diagnostic apparatus, a computerized tomography (CT) scanner, a magnetic resonance image (MRI) apparatus, a nuclear medicine diagnostic apparatus, and the like. In particular, the ultrasound system may display an interior body image in real time and thus is being variously used.

As the applicable field of the ultrasound system is currently being expanded, various demands are increasing on ultrasound images provided by the ultrasound system. In particular, for a surgical procedure such as a checkup, biopsy, surgery, and the like, there is a need to more precisely view a lesion or tissue of a patient. Therefore, the ultrasound system may need to obtain a multi-focal ultrasound image.

However, when obtaining the multi-focal ultrasound image, a frame rate of the ultrasound image provided from the ultrasound system may be significantly deteriorated. Accordingly, when a surgical procedure needs to be performed while viewing the ultrasound image in real time, the ultrasound system may provide an unnatural ultrasound image.

### SUMMARY

According to an aspect of the present invention, there is provided a method for frame interpolation of an ultrasound image, the method including: calculating an optical flow using an ultrasound image of a first frame and an ultrasound image of a second frame; determining an interpolated frame between the first frame and the second frame; calculating an optical flow of the interpolated frame using the calculated optical flow; and creating an ultrasound image in the interpolated frame from the optical flow of the interpolated frame.

In an aspect of the present invention, the optical flow may be an optical flow between the first frame and the second frame.

Also, the calculating of the optical frame using the ultrasound images may include: segmenting the ultrasound image of the first frame for each region; segmenting the ultrasound image of the second frame for each region; and calculating the optical flow from unit blocks of the first frame and the second frame.

Also, the determining of the interpolated frame may include determining the interpolated frame to be inserted between the first frame and the second frame according to change of a frame rate.

Also, the optical flow of the interpolated frame may be an optical frame between the first frame and the interpolated frame.

Also, the creating of the ultrasound image may include creating the ultrasound image in the interpolated frame using at least one of the optical flow of the interpolated frame, the ultrasound image of the first frame, the ultrasound image of the second frame, a frame interval between the first frame and the second frame, and a frame interval between the first frame and the interpolated frame.

According to another aspect of the present invention, there is provided an apparatus for frame interpolation of an ultrasound image, the apparatus including: a decision unit to determine an interpolated frame between a first frame and a second frame; a calculation unit to calculate an optical flow using an ultrasound image of the first frame and an ultrasound image of the second frame and to calculate an optical flow of the interpolated frame using the calculated optical flow; and a creation unit to create an ultrasound image in the interpolated frame from the optical flow of the interpolated frame.

According to embodiments of the present invention, there may be provided a method and apparatus for frame interpolation of an ultrasound image that may change a frame rate by inserting an interpolated frame to thereby provide a visually more natural multi-focal image in real time.

Also, according to embodiments of the present invention, there may be provided a method and apparatus for frame interpolation of an ultrasound image that may more effectively perform frame interpolation using an optical flow.

Also, according to embodiments of the present invention, there may be provided a method and apparatus for frame interpolation of an ultrasound image that may create an improved ultrasound image using an interpolated frame to thereby further enhance a surgical procedure using the improved ultrasound image.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an apparatus for frame interpolation of an ultrasound image according to an embodiment of the present invention;

FIG. 2 is a flowchart illustrating a method for frame interpolation of an ultrasound image according to an embodiment of the present invention; and

FIG. 3 is a flowchart illustrating an example of calculating an optical flow using an ultrasound image of a first frame and an ultrasound image of a second image shown in FIG. 2.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

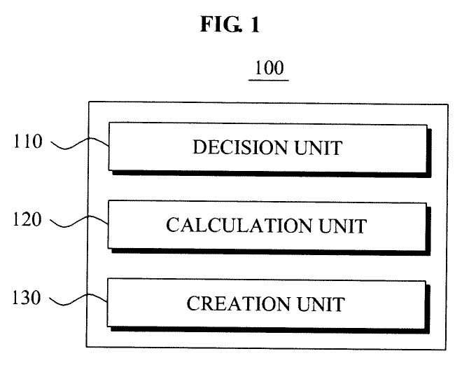

FIG. 1 is a block diagram illustrating an apparatus 100 for frame interpolation of an ultrasound image according to an embodiment of the present invention.

The frame interpolation apparatus 100 may improve the quality of the ultrasound image, displayed in real time, by changing a frame rate, particularly, by increasing the frame rate. When increasing the frame rate, the ultrasound image may look more natural and a user may be more satisfied with the quality of the ultrasound image.

The frame interpolation apparatus 100 may more effectively perform frame interpolation using an optical flow between frames.

Specifically, the frame interpolation apparatus 100 may calculate an optical flow between a first frame and a second frame using an ultrasound image of the first frame and an ultrasound image of the second frame, and may determine an interpolated frame between the first frame and the second frame. According to an embodiment of the present invention, the interpolated frame may be variously located, for example, in the middle of the first frame and the second frame, in a third point between the first frame and the second frame, and the like. Also, the frame interpolation apparatus 100 may determine a location of the interpolated frame based on predetermined standard information or reference information received from a user.

The frame interpolation apparatus 100 may calculate an optical flow corresponding to the location of the interpolated frame using the calculated optical flow. The optical flow of the interpolated frame may denote the optical flow between the first frame and the second frame.

The frame interpolation apparatus 100 may create an ultrasound image in the interpolated frame using the optical flow of the interpolated frame. In this instance, the frame interpolation apparatus 100 may create the ultrasound image in the interpolated frame by selectively using various parameters such as the optical flow of the interpolated frame, the ultrasound image of the first frame, the ultrasound image of the second frame, a frame interval between the first frame and the second frame, a frame interval between the first frame and the interpolated frame, and the like.

As shown in FIG. 1, the frame interpolation apparatus 100 constructed as above may include a decision unit 110, a calculation unit 120, and a creation unit 130.

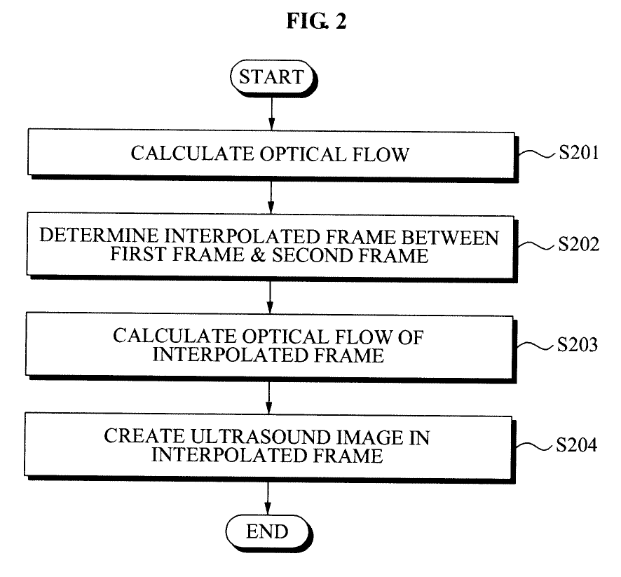

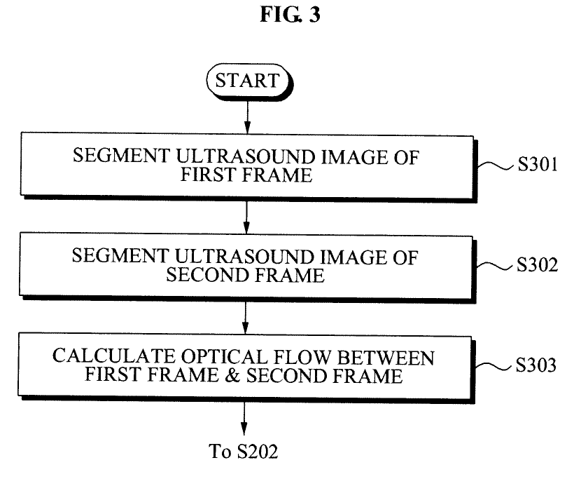

Hereinafter, a method of operating the frame interpolation apparatus 100 will be described in detail with reference to FIGS. 2 and 3.

FIG. 2 is a flowchart illustrating a method for frame interpolation of an ultrasound image according to an embodiment of the present invention.

As shown in FIG. 2, the frame interpolation method may be performed via operations S201 through S204. Operations S201 and S203 may be performed by the calculation unit 120. Operation S202 may be performed by the decision unit 110 and operation S204 may be performed by the creation unit 130.

In operation S201, the calculation unit 120 calculates an optical flow using an ultrasound image of a first frame and an ultrasound image of a second frame. The optical flow may denote an optical flow between the first frame and the second frame.

The optical flow may express, as a vector, a motion that externally appears in two different ultrasound images that are photographed by the frame interpolation apparatus 100 and input at different points in time. The above motion vector may be a speed distribution according to the motion in an image that may occur when slowly changing a brightness pattern between a previous frame and a current frame. Here, the previous frame and the current frame are temporally different.

The optical flow may be similar to the motion vector. However, the optical flow may measure a motion direction for each pixel and may have a faster detection speed than a full search scheme.

Representative examples of calculating the optical flow may include a Lucas & Kanade scheme and a Horn & Schunck scheme. Specifically, the Lucas & Kanade scheme denotes a scheme that may calculate the optical flow using a partial differentiation over time with respect to pixels. The Horn & Schunck scheme denotes a scheme that may calculate the optical flow by combining an optical flow bound equation of each pixel in adjacent eight directions and calculating a minimum value of satisfying a bound condition according to a least square scheme, under the assumption that the same optical flow exists within a predetermined region.

According to an embodiment of the present invention, the calculation unit 120 may calculate the optical flow using the ultrasound image of the first frame and the ultrasound image of the second frame based on the Lucas & Kanade scheme. However, the present invention is not limited thereto. Specifically, in order to determine the optical flow, the calculation unit 120 may employ various types of schemes including the Horn & Schunck scheme.

Hereinafter, operation S201 will be further described in detail with reference to FIG. 3.

FIG. 3 is a flowchart illustrating an example of operation S201 of FIG. 2.

As shown in FIG. 3, operation S201 may be performed via operations S301 through S303. Operations S301 through S303 may be performed by the calculation unit 120.

In operation S301, the calculation unit 120 segments the ultrasound image of the first frame for each region.

According to an embodiment of the present invention, the calculation unit 120 may compare each of pixels included in the ultrasound image of the first frame with all the pixels included in the ultrasound image of the second frame. For more efficient processing, the calculation unit 120 may segment the ultrasound image of the first frame for each segment. Specifically, the calculation unit 120 may segment the ultrasound image of the first frame into a plurality of unit blocks including a predetermined pixel.

In operation S302, the calculation unit 120 segments the ultrasound image of the second frame for each region.

Specifically, while moving the ultrasound image of the second frame based on a pixel unit, the calculation unit 120 may segment the ultrasound image of the second frame into unit blocks having the same size as the unit blocks of the first frame.

In operation S303, the calculation unit calculates the optical flow from the unit blocks of the first frame and the second frame.

Specifically, the calculation unit 120 may compare the unit block of the ultrasound image of the first frame and the unit block of the ultrasound image of the second frame to acquire a difference value in the unit block such as a luminance, a chromaticity, and the like. The calculation unit 120 may calculate the optical flow based on the difference value. Also, according to an embodiment of the present invention, the calculation unit 120 may calculate the optical flow via the partial differentiation over time with respect to pixels, based on the unit blocks of the ultrasound images of the first frame and the second frame, using the Lucas & Kanade scheme.

In operation S202, the decision unit 110 determines an interpolated frame between the first frame and the second frame. Specifically, the decision unit 110 may determine the interpolated frame to be inserted between the first frame and the second frame. For example, when the frame rate changes from 10 frames per second to 20 frames per second, the decision unit 110 may insert the interpolated frame in the middle of the first frame and the second frame.

In operation S203, the calculation unit 120 calculates an optical flow of the interpolated frame using the calculated optical flow. In this instance, the optical flow of the interpolated frame may denote an optical flow between the first frame and the second frame.

Specifically, the calculation unit 120 may calculate an optical flow between the first frame and the interpolated frame using the optical flow between the first frame and the second frame and a parameter according to a location of the interpolated frame. For example, the parameter according to the location of the interpolated parameter may be a time interval between the first frame and the interpolated frame or a time interval between the interpolated frame and the second frame.

In operation S204, the creation unit 120 creates an ultrasound image in the interpolated frame from the optical flow of the interpolated frame.

Specifically, the creation unit 120 may synthesize the ultrasound image in the interpolated frame using the optical flow of the interpolated frame that is estimated from the optical flow between the first frame and the second frame.

In this instance, the creation unit 120 may synthesize the ultrasound image in the interpolated frame using at least one of the optical flow of the interpolated frame, the ultrasound image of the first frame, the ultrasound image of the second frame, a frame interval between the first frame and the second frame, and a frame interval between the first frame and the interpolated frame.

Although not shown in FIGS. 2 and 3, the frame interpolation apparatus 100 may display an ultrasound image, newly created according to the frame interpolation, and an existing ultrasound image according to a frame order. Due to change of the frame rate, the user may view a visually more natural ultrasound image.

The frame interpolation method of the ultrasound image according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for frame interpolation of an ultrasound image, the method comprising:
calculating an optical flow using an ultrasound image of a first frame and an ultrasound image of a second frame;
determining an interpolated frame between the first frame and the second frame;
calculating an optical flow of the interpolated frame using the calculated optical flow; and
creating an ultrasound image in the interpolated frame from the optical flow of the interpolated frame.

2. The method of claim 1, wherein the optical flow is an optical flow between the first frame and the second frame.

3. The method of claim 2, wherein the calculating of the optical frame using the ultrasound images comprises:
segmenting the ultrasound image of the first frame for each region;
segmenting the ultrasound image of the second frame for each region; and
calculating the optical flow from unit blocks of the first frame and the second frame.

4. The method of claim 1, wherein the determining of the interpolated frame comprises determining the interpolated frame to be inserted between the first frame and the second frame according to change of a frame rate.

5. The method of claim 1, wherein the optical flow of the interpolated frame is an optical frame between the first frame and the interpolated frame.

6. The method of claim 1, wherein the creating of the ultrasound image comprises creating the ultrasound image in the interpolated frame using at least one of the optical flow of the interpolated frame, the ultrasound image of the first frame, the ultrasound image of the second frame, a frame interval between the first frame and the second frame, and a frame interval between the first frame and the interpolated frame.

7. A computer-readable recording medium storing a program for implementing the method of claim 1.

8. An apparatus for frame interpolation of an ultrasound image, the apparatus comprising:
a decision unit to determine an interpolated frame between a first frame and a second frame;
a calculation unit to calculate an optical flow using an ultrasound image of the first frame and an ultrasound image of the second frame and to calculate an optical flow of the interpolated frame using the calculated optical flow; and
a creation unit to create an ultrasound image in the interpolated frame from the optical flow of the interpolated frame.

9. The apparatus of claim 8, wherein, when calculating the optical flow using the ultrasound image of the first frame and the ultrasound image of the second frame, the calculation unit segments the ultrasound image of the first frame for each region, segments the ultrasound image of the second frame for each region, and calculates the optical flow from unit blocks of the first frame and the second frame.

10. The apparatus of claim 8, wherein the decision unit determines the interpolated frame to be inserted between the first frame and the second frame according to change of a frame rate.

11. The apparatus of claim 8, wherein the creation unit creates the ultrasound image in the interpolated frame using at least one of the optical flow of the interpolated frame, the ultrasound image of the first frame, the ultrasound image of the second frame, a frame interval between the first frame and the second frame, and a frame interval between the first frame and the interpolated frame.
